(19) United States
(12) Patent Application Publication
(10) Pub. No.: US 2019/0157780 A1
(43) Pub. Date: May 23, 2019

(54) ELECTRICAL CONDUCTOR CONNECTION

(71) Applicant: HARTING Electronics GmbH, Espelkamp (DE)

(72) Inventors: Martin LUECKEMEIER, Diepenau (DE); Andreas HUHMANN, Espelkamp (DE)

(21) Appl. No.: 16/302,034

(22) PCT Filed: May 17, 2017
(86) PCT No.: PCT/DE2017/100419

§ 371 Date: Nov. 15, 2018

(30) Foreign Application Priority Data
Jun. 23, 2016 (DE) 10 2016 111 565.7

(51) Int. Cl. H01R 12/51

(52) U.S. Cl. CPC H01R 12/515; H01R 12/58; H01R 2201/20

(57) ABSTRACT

An electrical conductor connection element has a contact carrier, at least one first contact element and at least one second contact element. An electrical conductor can be connected to and contacted with the conductor connection element on the first contact element. The second contact element is connected to the first contact element and guided on the outside of the contact carrier. The conductor connection element furthermore has a separation point which serves to separate the electrical connection of the first contact element to the second contact element.

The invention starts with an electrical conductor connection element for contacting an electrical conductor on a printed circuit board or an electrical appliance according to the precharacterizing clause of the independent claim 1.

Conductor connection elements of this type are required to connect electrical conductors, cables or wires electrically to components, appliances or other electrical devices. In this case, a reliable electrical and mechanical connection of the conductor, cable or wire to the device must be ensured. The electrical contact is usually established via a mechanical contact element. In this case, the contact element is formed as a spring or screw contact. The conductor or cable can be mechanically and thus also electrically connected via the spring or screw force.

### PRIOR ART

DE 10 2006 018 129 C5 discloses a spring loaded terminal having at least one leg spring arranged in a housing. In this case, the leg spring is configured for contacting an inserted conductor and is electrically connected to contact pins of the spring loaded terminal. Via the contact pins, the spring loaded terminal can be contacted on a printed circuit board and the connected conductor can therefore be electrically connected to the printed circuit board.

An electrical connecting terminal having an insulating material housing and having at least one spring terminal connection in the insulating material housing is known from DE 10 2010 048 698 A1. The spring terminal connection is electrically connected to a plug connector, which is formed as a solder pin or solder pad. The electrical connecting terminal can be electrically connected to a housing or appliance, for example, via the plug connector. The spring terminal connection in the insulating material housing is provided for reversibly contacting an electrical conductor.

The conductor connection elements known from the prior art are disadvantageous in that error-free testing of the contact and connection point of the conductor to the conductor connection element is not possible. Conductor connection elements of this type are usually already installed on an appliance or a printed circuit board before an electrical conductor or an electrical cable is connected thereto. If the contact point between the conductor connection element and the conductor is to be checked in terms of its electrical properties, the result is always distorted by the components and electrical elements of the appliance or the printed circuit board on which the conductor connection element is assembled since the conductor connection element is already electrically connected thereto. It is not possible to measure or check the insulated contact point or simply the conductor connection element with the cable connected thereto.

### OBJECT

The invention is therefore based on the object of presenting a conductor connection element which enables electrical measurement of the connection point between the conductor connection element and the connected cable. In this case, the aim is to prevent the measurement from being distorted by further electrical elements which are already connected to the conductor connection element.

The object is achieved by the characterizing features of the independent claim 1.

Advantageous designs of the invention are described in the subclaims.

The invention relates to an electrical conductor connection element, which is formed by a contact carrier, at least one first contact element received therein and at least one second contact element connected to the first contact element. The second contact element is received in the contact carrier in certain regions and arranged outside the contact carrier in certain regions. Outside the contact carrier, the second contact element forms a second connection region which is provided for electrical contacting of the conductor connection element. Therefore, the second connection region can, for example, be soldered to a printed circuit board, pressed into a printed circuit board or attached in another electrically conductive manner. For this, the second connection region of the second contact element can be formed, for example, as a so-called press-in contact for pressing directly into a contact hole of a printed circuit board. Alternatively, a soldered contact for the soldered attachment of the second connection region would also be conceivable. The contact carrier is preferably manufactured from an electrically insulating material such as a polymer, for example.

The first contact element, which is received in the contact carrier, is provided for mechanical and electrical contacting of an electrical conductor, cable or wire. In this case, the first contact element can be formed as a spring contact or screw contact. Depending on the application and field of use, different contact types known form the prior art can be used here. In the case of such conductor connection elements, so-called cage tension springs or push-in contacts are frequently used since they are suitable for particularly simple assembly and disassembly of a cable or wire.

To connect a cable, a conductor or a wire to the first contact element, a conductor receiving opening is formed in the contact carrier. This conductor receiving opening enables the first contact element arranged onto the in the contact carrier to be accessed. A conductor, a wire or a cable can be guided through the conductor receiving opening into the contact carrier and connected there to the first contact element. Known embodiments of conductor connection elements provide for either forming a further opening in the contact carrier or designing the conductor receiving opening so that it is large enough for a tool, such as a screwdriver, for example, to be inserted into the contact carrier to thereby open the first connection region of the first contact element and release a connected cable, conductor or wire.

According to the invention, the electrical conductor connection element has a disconnection point. The disconnection point is arranged in the contact carrier and is provided for electrically disconnecting the conductive connection between the first contact element and the second contact element. That is to say that the disconnection element opens the electrical connection between the first contact element and the second contact element so that a current can no longer flow. A preferred embodiment provides for the disconnection point to be formed between a first contact region of the first contact element and a second contact region of the second contact element.

The first contact element therefore has a first contact region and the second contact element therefore has a second contact region. The first contact region and the second contact region are in mechanical and electrical contact so that a current can flow from the first contact element to the second contact element.

The disconnection point should therefore be seen as an electrical switch, which opens the connection between the first contact element and the second contact element. That is to say that the disconnection point is an electrical break contact, i.e. a mechanical disconnection switch. For this, the disconnection point has at least one movable part which is configured to open the electrical connection. In this case, the movable part of the disconnection point is preferably a resilient region which can be deflected by introducing a force until the disconnection point is open. When the force is removed, the movable part springs back into its starting bearing and closes the disconnection point. The first contact region of the first contact element is preferably produced from a resilient material and therefore forms the movable part of the disconnection point.

A preferred embodiment of the present invention provides for the contact carrier to have a test opening. Access to the interior of the contact carrier is possible through the test opening. According to the invention, the disconnection point in the contact carrier is arranged at the test opening. That is to say that access to the disconnection point located in the contact carrier is enabled through the test opening. By means of a corresponding tool, for example a pin or a test probe, the disconnection point can be actuated through the test opening and the electrical connection between the first contact element and the second contact element can be opened.

In this case, it is particularly advantageous that the movable part of the disconnection point is provided on the first contact element. The movable part of the disconnection point can thus be actuated through the test opening by a test probe and the disconnection point can thus be opened. However, since the movable part is still electrically connected to the first connection region, the object according to the invention can therefore be achieved and a measurement of the contact of a connected cable, conductor or wire with the first contact region of the first contact element can be carried out. Therefore, a measurement of the contact point cannot be distorted by further components or electrical elements which are connected to the conductor connection element via the second connection region of the second contact element.

As a result of the features according to the invention, the electrical conductor connection element can have two states: a first, closed operating state and a second, opened test state. In the first, closed operating state, the disconnection point is closed. The first contact element has an electrical connection to the second contact element. In the second, opened test state, a test probe, for example, is inserted into the contact carrier through the test opening. The test probe actuates the movable part of the disconnection point and opens this latter. An electrical connection between the first contact element and the second contact element is not present. For this, the electrical contact of a connected cable with the first contact element can be checked by the test probe.

A special embodiment provides for receiving a plurality of first and second contact elements in the contact carrier. Accordingly, a plurality of disconnection points are also present in the contact carrier. Therefore, each first contact element and the cable, conductor or wire connected thereto can be checked individually according to the present invention.

Further expedient embodiments of the present invention provide for also forming the first connection region of the first contact element as a soldered contact or press-in contact for establishing contact between this and a printed circuit board. Therefore, according to the invention, an electrical connection on a printed circuit board can be disconnected and electrically checked. An embodiment in which the second connection region of the second contact element is formed as a spring contact, screw contact, cage tension spring or push-in contact would likewise be useful. A connection between two conductors or cables could therefore be electrically disconnected and checked.

### EXEMPLARY EMBODIMENT

An exemplary embodiment of the invention is illustrated in the drawings and will be explained in more detail below. The drawings show:

FIG. 1 a first exemplary embodiment of a first, closed operating state of a conductor connection element in a sectional illustration;

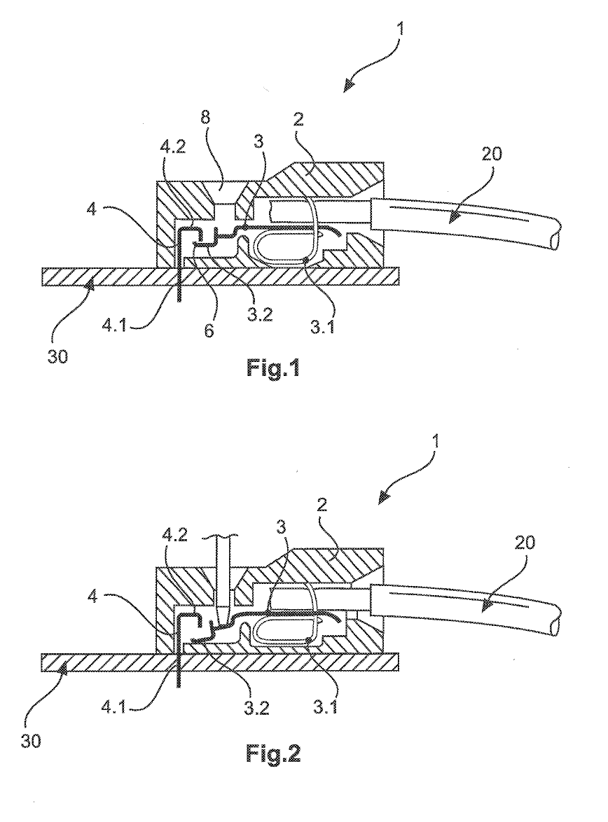

FIG. 2 a second, opened test state of the conductor connection element of FIG. 1 in a sectional illustration;

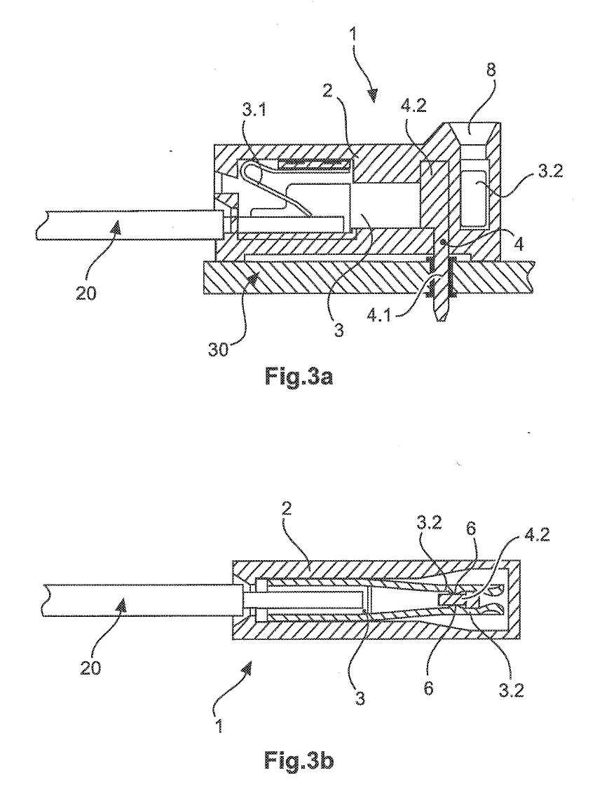

FIG. 3 a first, closed operating state of a second exemplary embodiment of a conductor connection element in two sectional illustrations (FIGS. 3a and 3b); and

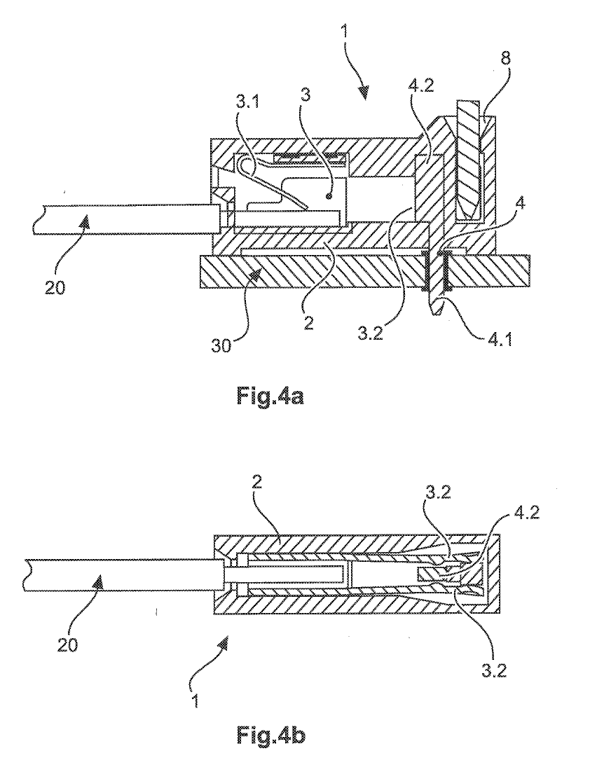

FIG. 4 a second, opened test state of the conductor connection element of FIG. 3 in two sectional illustrations (FIGS. 4a and 4b).

The figures contain partially simplified, schematic illustrations. Identical reference signs are sometimes used for elements which are similar, but possibly not identical. Varying views of similar elements could be drawn to different scales.

FIG. 1 shows a first, closed operating state of an electrical conductor connection element 1 in a sectional illustration. The conductor connection element 1 is formed by a contact carrier 2, which is arranged on the surface of a printed circuit board 30 at the end thereof. A cable 20 is connected to the conductor connection element 1 and inserted into the contact carrier 2 from the right. For this, a conductor receiving opening 7 is formed in the contact carrier 2, through which the cable 20 can be introduced into the contact carrier 2 here from the right.

A first contact element 3 is arranged in the contact carrier 2 of the conductor connection element 1. The first contact element 3 is provided in the interior of the contact carrier 2 and reaches into the right-hand region in which the cable 20 is also inserted through the conductor receiving opening 7. In the right-hand region, the first contact element 3 forms a first connection region 3.1. The cable 20 is inserted and connected into the first connection region 3.1 via the conductor receiving opening 7. The first connection region 3.1 of the first contact element 3 is formed as a cage tension spring, a so-called cage clamp, in this exemplary embodiment.

The first contact element 3 is connected to a second contact element 4 in the contact carrier 2. The second contact element 4 contacts the first contact element 3 with one end in the interior of the contact carrier 2. The second end of the second contact element 4 forms a second connection region 4.1. outside the contact carrier 2. The second connection region 4.1. is received in the printed circuit board 30 and electrically connected thereto. In the first, closed operating state shown, the conductor connection element 1 therefore establishes an electrical connection between the connected cable 20 and the printed circuit board 30.

In the contact carrier 2, a further opening, a test opening 8, is provided above the first contact element 3. The test opening 8 enables access to a first contact region 3.2 of the first contact element 3 from outside the contact carrier 2. According to the invention, a disconnection point 6 is provided directly below the test opening 8. The disconnection point 6 is formed by the first contact region 3.2 of the first contact element 3 together with a second contact region 4.2 of the second contact element. The first contact region 3.2 and the second contact region 4.2 are touching one another and are therefore mechanically and electrically connected.

The second contact region 3.2 of the first contact element 3 is constructed to be movable, at least in certain regions. In this case, the region of the disconnection point 6 is resiliently formed and therefore functions as a switch, especially as an opening switch. The first contact element 3 and the second contact element 4 can therefore be opened at the disconnection point 6 as a result of a flexible deformation of the first contact region 3.2. In the illustrated, closed operating state of the conductor connection element 1, the movable part of the first contact region 3.2 springs upwards so that the disconnection point 6 is closed.

A second, opened test state of a conductor connection element 1 is shown in a sectional illustration in FIG. 2. In this test state, the disconnection point 6 is opened and the electrical connection of the first contact element 3 and the second contact element 4 is therefore disconnected.

A test probe is inserted into the test opening 8. The test probe projects into the contact carrier 2 through the test opening 8 until it reaches the disconnection point 6. By means of the test probe, the movable part of the disconnection point 6 is reversibly deflected and pressed downwards. The the first contact element 3 and the second contact element 4 are disconnected as a result of the flexible deformation of the first connection region 3.2 at the disconnection point 6. The electrical connection between the first contact element 3 and the second contact element 4 is disconnected.

At the same time, a measurement of the contact element 3 with the connected cable 20 can be carried out at the disconnection point 6 by means of the test probe. In this case, the measurement is not influenced by electrical components or voltages which are applied to the second connection region 4.1 of the second contact element 4 via the printed circuit board 30.

When the test probe is removed from the test opening 8, the movable part of the first contact region 3.2 springs back upwards and closes the contact of the disconnection point 6.

FIGS. 3a, 3b, 4a and 4b show a second exemplary embodiment of the present invention. In this case, FIGS. 3a and 4a each show a sectional illustration through the electrical conductor connection element 1. FIGS. 3b and 4b each show a further sectional illustration, wherein the section through the electrical conductor connection element 1 has been rotated through 90°. FIGS. 3a, 3b show the electrical conductor connection element 1 in a first, closed operating state, whist the electrical conductor connection element 1 in FIGS. 4a, 4b is illustrated in a second, opened test state.

In this second exemplary embodiment, the first connection region 3.1 of the first contact element 3 is constructed as a so-called push-in contact. An electrical conductor can be directly inserted and connected into this. In this exemplary embodiment, the first contact element 3 has two mutually opposing first contact regions 3.2. The second contact region 4.2 of the second contact element 4 is arranged between the first contact regions 3.2. The second contact element 4 is aligned perpendicularly to the first contact element 3 and forms the second connection region 4.1 below the contact carrier 2.

In the second, opened test state shown in FIGS. 4a, 4b, a test probe is inserted into the contact carrier 2 via the test opening 8. The test probe is arranged between the two first contact regions 3.2 of the first contact element 3 so that the two first contact regions 3.2 can be spread apart by the test probe. For this, the test probe is configured with a strength which enables it to effect adequate spreading, i.e. a sideways movement of the two first contact regions 3.2 away from the second contact region 4.2. As a result of the first contact regions 3.2 being deflected away from the second contact region 4.2, their mutual mechanical and electrical contact is broken and the two contact points 6 are therefore opened.

1. An electrical conductor connection element having a contact carrier, at least one first contact element and at least one second contact element,
wherein the first contact element is received in the contact carrier and connected to the second contact element in an electrically conductive manner,
wherein the first contact element forms a first connection region and, within the contact carrier, a first contact region, and
the second contact element forms a second connection region and, within the contact carrier, a second contact region,
wherein
the electrical conductor connection element has at least one disconnection point, wherein the electrically conductive connection between the first contact element and the second contact element can be disconnected by the disconnection point.

2. The electrical conductor connection element as claimed in claim 1,
wherein
the contact carrier has a conductor receiving opening for receiving an electrical conductor.

3. The electrical conductor connection element as claimed in claim 1, wherein
the first contact element in the first connection region is formed as a spring contact or a screw contact or a cage tension spring or a push-in contact and is provided for connection of an electrical conductor, or in that
the first contact element in the first connection region is formed as a press-in contact or soldered contact and is provided for contacting a printed circuit board.

4. The electrical conductor connection element as claimed in claim 1, wherein
the second contact element in the second connection region is formed as a press-in contact or soldered contact and is provided for contacting a printed circuit board or in that
the second contact element in the second connection region is formed as a spring contact or a screw contact or a cage tension spring or a push-in contact and is provided for connection of an electrical conductor.

5. The electrical conductor connection element as claimed in claim 1, wherein
the contact carrier has a test opening.

6. The electrical conductor connection element as claimed in claim 5, wherein
the first contact region and the second contact region in the contact carrier is arranged at the test opening.

7. The electrical conductor connection element as claimed in claim 1, wherein
the disconnection point in the contact carrier is arranged at the test opening.

8. The electrical conductor connection element as claimed in claim 1, wherein
the first contact region and the second contact region are in mechanical contact and form the disconnection point.

9. The electrical conductor connection element as claimed in claim 8,
wherein
at least the first contact region or the second contact region is formed as a movable part of the disconnection point.

10. The electrical conductor connection element as claimed in claim 8,
wherein
the first contact region of the first contact element is formed as a movable part of the disconnection point.

11. The electrical conductor connection element as claimed in claim 8, wherein
the movable part of the disconnection point consists of a resilient material, at least in certain regions.

12. The electrical conductor connection element as claimed in claim 1, wherein
a plurality of first contact elements, a plurality of second contact elements and a plurality of disconnection points is arranged in equal number in the contact carrier.

13. The electrical conductor connection element as claimed in claim 1, wherein
the contact carrier consists of an electrically insulating material.

14. The electrical conductor connection element as claimed in claim 1, wherein
the electrical conductor connection element is configured to have a first, closed operating state and a second, opened test state, wherein the disconnection point is closed in the first, closed operating state and the disconnection point is opened in the second, opened test state.

15. The electrical conductor connection element as claimed in claim 1, wherein
the first contact element consists of a resilient material at least in certain regions, preferably the first contact region of the first contact element.

16. The electrical conductor connection element as claimed in claim 1, wherein
the first connection region of the first contact element is arranged within the contact carrier or at least partially outside the contact carrier and in that the second connection region of the second contact element is arranged within the contact carrier or at least partially outside the contact carrier.

17. The electrical conductor connection element as claimed in claim 6, wherein the disconnection point in the contact carrier is arranged at the test opening.

18. The electrical conductor connection element as claimed in claim 9, wherein the movable part of the disconnection point consists of a resilient material, at least in certain regions.

19. The electrical conductor connection element as claimed in claim 10, wherein the movable part of the disconnection point consists of a resilient material, at least in certain regions.
